(19) United States
(12) Patent Application Publication
(10) Pub. No.: US 2010/0053342 A1
(43) Pub. Date: Mar. 4, 2010

(54) IMAGE EDIT METHOD AND APPARATUS FOR MOBILE TERMINAL

(75) Inventors: Yong Duk Hwang, Daegu Metropolitan City (KR); Sung Hm Yun, Gumi-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/546,229

(22) Filed: Aug. 24, 2009

(30) Foreign Application Priority Data
Sep. 4, 2008 (KR) 10-2008-0087338

(51) Int. Cl. H04N 5/225

(52) U.S. Cl. 348/207.99; 348/E05.024

(57) ABSTRACT

An image edit method and apparatus for a mobile terminal having a touchscreen is provided for intuitively editing images by means of edit tools provided in the touchscreen. The image edit method includes displaying a first image with an edit tool in the touchscreen, breaking, when the first image is a motion picture, the first image into a plurality of frames and editing at least one of the frames using the edit tool in accordance with user manipulation, and acquiring, when the first image is a still image, a second image from an image source, and generating a third image by synthesizing the first and second images.

### PRIORITY

This application claims the benefit under 35 U.S.C. §119(a) of a Korean patent application filed in the Korean Intellectual Property Office on Sep. 4, 2008 and assigned Serial No. 10-2008-0087338, the entire disclosure of which is hereby incorporated by reference.

### BACKGROUND OF THE INVENTION

1. Field of the Invention

The present invention relates to a mobile terminal. More particularly, the present invention relates to an image edit method and apparatus for a mobile terminal having a touchscreen that enables intuitive editing of images by inputting various edit commands using edit tools provided on the touchscreen.

2. Description of the Related Art

Personal information processing devices, including a Personal Computer (PC) and a portable communication device, are provided with diverse input devices (such as a keyboard, a mouse, and a digitizer) to allow commands to be input for processing text and graphic images. Among the input devices, the digitizer is implemented with a specially fabricated flat panel on which a contact of a finger or a stylus is detected and an x-y coordinate of the contact point is output. The digitizer is advantageous when inputting a character or drawing an image and is more convenient and precise than a mouse or a keyboard.

A touchscreen can be classified as a type of digitizer that is implemented on the front surface of a display panel (e.g. a Liquid Crystal Display (LCD) panel) for intuitive, rapid, and accurate interaction by a user with an image displayed thereon. In a mobile terminal equipped with a touchscreen, image editing can be carried out more efficiently with an intuitive graphical touchscreen interface.

In the meantime, with the widespread use of mobile terminals, more and more supplementary functions are integrated into mobile terminals. In recent mobile terminals, a camera module has become a basic part such that the user can take still or motion pictures using the mobile terminal. Typically, the camera-enabled mobile terminal provides a picture edit application such that the user can edit the picture taken by the camera module. The picture taken by the camera can be edited and designated as an idle mode image, a power-on image, a power-off image, and an incoming call image.

The image edit function of the mobile terminal is limited to simple modification such as changing the size of the picture and adding a special effect to the image. Even this simple edit operation is inconvenient due to the limited input means on the mobile terminal. Accordingly, most mobile terminal users edit pictures using a more powerful edit application in their personal computer and then download the edited pictures to their mobile terminal.

In addition, the image edit function of the conventional touchscreen-enabled mobile terminal is achieved by means of a stylus pen while the target image is displayed on the touchscreen. In order to edit the image displayed on the touchscreen, the user selects a specific section of the image using the stylus pen and applies a specific edit command to the selected section.

However, the conventional touchscreen-enabled mobile terminal has a drawback in that the image edit operation is performed through multiple steps with manipulation of keys or key combinations, whereby the user is likely to feel frustration with laborious key strokes and complex manipulations.

### SUMMARY OF THE INVENTION

An aspect of the present invention is to address at least the above-mentioned problems and/or disadvantages and to provide at least the advantages described below. Accordingly, an aspect of the present invention is to provide an image edit method and apparatus for a touchscreen-enabled mobile terminal that is capable of providing the user with an improved image edit interface.

Another aspect of the present invention is to provide an image edit method and apparatus for a mobile terminal having a touchscreen that is capable of facilitating the image edit operation by means of the touchscreen.

A further aspect of the present invention is to provide an image edit method and apparatus for a mobile terminal having a touchscreen that is capable of editing various types of images stored in the mobile terminal conveniently using an enhanced image edit tool.

In accordance with an aspect of the present invention, an image edit method for a mobile terminal is provided. The method includes displaying a first image with an edit tool, breaking, when the first image is a motion picture, the first image into a plurality of frames and editing at least one of the frames using the edit tool in accordance with user manipulation, and acquiring, when the first image is a still image, a second image from an image source, and generating a third image by synthesizing the first and second images.

In accordance with another aspect of the present invention, an image edit method for a mobile terminal having a touchscreen is provided. The method includes displaying a first image with an edit tool in the touchscreen, selecting an area of the first image using a marquee function of the edit tool, capturing a second image after selecting the area of the first image, placing the second image within the selected area of the first image, and generating a third image by synthesizing the second image and first image as a background of the second image.

In accordance with yet another aspect of the present invention, an image edit method for a mobile terminal having a touchscreen is provided. The method includes displaying a first image with an edit tool in the touchscreen, selecting an area of the first image using a lasso function of the edit tool, capturing a second image after selecting the area of the first image, overlaying the selected area of the first image on the second image, and generating a third image by synthesizing the selected area of the first image and the second image as a background of the selected area.

In accordance with still another aspect of the present invention, a mobile terminal having a camera unit is provided. The terminal includes a display unit for displaying at least one image taken by means of the camera unit together with an edit tool and for detecting an input event by means of a touchscreen, and a control unit for controlling the display unit to display a first image taken by the camera unit together with the edit tool, for controlling the camera unit to capture a second image when the first image is edited, and for generating a third image by synthesizing the first and second images.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a flowchart illustrating an image edit method for a mobile terminal according to an exemplary embodiment of the present invention;

FIG. 2 is a flowchart illustrating an image edit method for a mobile terminal according to an exemplary embodiment of the present invention;

FIG. 3 is a flowchart illustrating an image edit method for a mobile terminal according to an exemplary embodiment of the present invention;

FIG. 4 is a diagram illustrating a series of screen images corresponding to steps of a motion image edit method according to an exemplary embodiment of the present invention;

FIG. 5 is a diagram illustrating a series of screen images corresponding to steps of a still image edit procedure using a marquee tool according to an exemplary embodiment of the present invention;

FIG. 6 is a diagram illustrating a series of screen images corresponding to steps of a still image edit procedure using a lasso tool according to an exemplary embodiment of the present invention; and

FIG. 7 is a block diagram illustrating a configuration of a mobile terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In an exemplary embodiment, the present invention provides an enhanced User Interface (UI) and a method and apparatus for editing images using the user interface. More particularly in an exemplary embodiment of the present invention, a touchscreen-enabled mobile terminal provides an image edit application on the touchscreen such that an image displayed on the touchscreen can be edited in response to touch events detected on the touchscreen by means of the edit tool intuitively and interactively.

In an exemplary embodiment of the present invention, the image can be any kind of still and motion images. In an exemplary embodiment of the present invention, the term “frame” denotes one of still images constituting a motion image. In an exemplary embodiment of the present invention, the difference between the still image and the motion image is that the objects of the still image are motionless and the objects of the motion image are in motion. Unlike the still image consisted of a single image frame, the motion image includes a series of frames that are continuously presented.

Although an image edit operation is described in an exemplary embodiment of the present invention, the present invention is not limited thereto. For instance, the present invention can be applied for editing various content items as well as images. Here, the content items include various data objects such as texts, audio, and documents. That is, the edit operation can be performed on all kinds of data objects handled in the mobile terminal. In addition, the edit operation can be an operation of combining at least two different types of items.

A user interface and operations of the mobile terminal according to an exemplary embodiment invention are described hereinafter with reference to the exemplary screen images. However, the present invention is not limited to the following description and could be implemented with some modifications to the various embodiments.

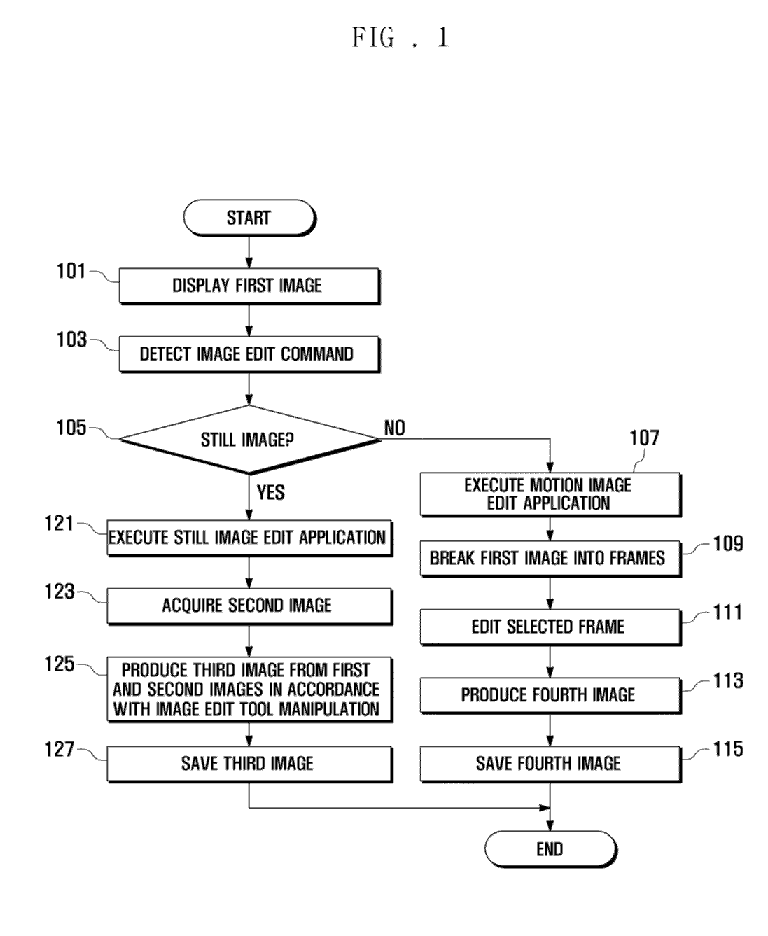

FIG. 1 is a flowchart illustrating an image edit method for a mobile terminal according to an exemplary embodiment of the present invention.

Referring to FIG. 1, in response to a user command for requesting a first image, the mobile terminal acquires and displays the first image on a display screen in step 101. The first image can be a picture taken by a camera module in response to a user request. The first image also can be a picture retrieved from a storage of the mobile terminal. In an exemplary embodiment of the present invention, the image can be a still image or a motion image. Accordingly, the first image can be a still image or a motion image taken by means of the camera module or retrieved from the storage.

Next, the mobile terminal detects an image edit command input by the user while displaying the first image in step 103. If an image edit command is detected, the mobile terminal determines whether the first image is a still image or a motion image in step 105. If the first image is a motion image, the mobile terminal executes a motion image edit application in step 107. Although it is described that the still image is edited with a still image edit application and the motion image is edited with a motion image edit application in order to simplify the explanation, the still and motion images can be edited with same image edit application. Here, the motion image can be created by the user arranging a series of still images as well as capturing the motion image with the camera module.

After executing the motion image edit application, the mobile terminal breaks the first image into sequence of image frames in step 109. For instance, the mobile terminal determines an image edit mode for editing the first image according to a menus selection by the user. In a case where the image edit mode selected by the user is a frame break mode, the mobile terminal extracts the sequence of the still images constituting the motion image and displays the still images together with the motion image. Hereinafter, each of the still images constituting the motion image is called an image frame.

After breaking the motion image into a sequence of image frames, the mobile terminal selects and edits at least one image frame in response to the user command in step 111. The image edit commands may include “delete”, “move”, and “add”. In response to the move command input by the user, the mobile terminal can insert a specific image frame between two consecutive image frames. In addition, the mobile terminal can add an object (such as text, sound, and emoticon) to a selected image frame and adjust the brightness and transparency of the selected image frame.

Next, the mobile terminal produces a fourth image obtained by editing the first image in response to an edit complete command in step 113 and stores the fourth image in response to a save command input by the user in step 115. The fourth image can be overwritten on the first image or saved as a new file.

Returning to step 105, if the first image is a still image, the mobile terminal executes a still image edit application in step 121.

After executing the still image edit application, the mobile terminal acquires and displays a second image on the display screen in response to a user command requesting the second image in step 123. The request for the second image can be input after the first image is edited by means of the still image edit application. The second image request process is described in detail further below. The second image can be displayed with the first image simultaneously. The second image can be a picture taken by the camera module in response to a user command. The second image also can be a picture retrieved from the storage of the mobile terminal. The second image can be replaced with one of other types of objects including text, emoticon, and their equivalents supported by the mobile terminal.

Next, the mobile terminal produces a third image by editing and synthesizing the first image with the second image in accordance with the user manipulation with the edit tool in step 125. In the still image edit process, the first and second images can be edited independently and then combined together with each other to create the third image.

Once the image edit has completed in accordance with an image edit complete command input by the user, the mobile terminal stores the third image obtained as described above in response to the user command in step 127. In a case where both the first and second images are pictures taken by means of the camera module, the pictures taken by the camera module are designated as the first and second images in temporal order and the picture created by editing the pictures taken by the camera module can be designated as the third image. The mobile terminal can store all the first to third images separately or only the third image.

Until now, the image edit procedure using the image edit application in the mobile terminal according to the present invention is described schematically. The steps of the image edit procedure of FIG. 1 are described in more detail with reference to exemplary screen images.

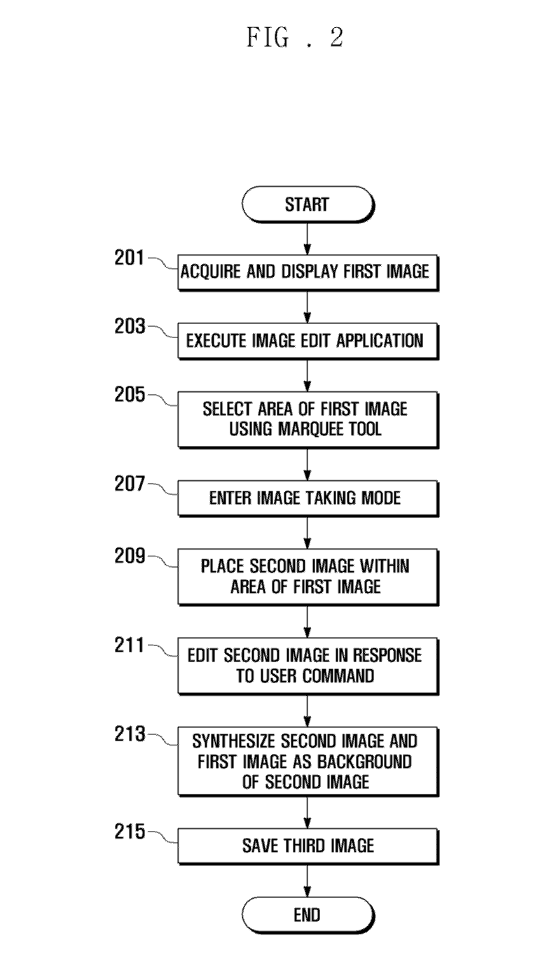

FIG. 2 is a flowchart illustrating an image edit method for a mobile terminal according to an exemplary embodiment of the present invention. More particularly, FIG. 2 illustrates an exemplary image edit procedure in which the first and second images taken by means of a camera module are edited using a marquee tool and the image obtained from the first and second images is saved as a third image.

Referring to FIG. 2, the mobile terminal first acquires and displays a first image on a display screen in step 201. The first image can be a picture taken by means of the camera module of the mobile terminal in response to a user command. In an exemplary embodiment of the present invention, the image can be a still image or a motion image. In FIG. 2, the first image can be a still image or a motion image taken by means of the camera module, which is integrated with the mobile terminal.

While the first image is displayed on the display screen, the mobile terminal executes an image edit application in response to an image edit command input by the user in step 203. The image edit application can be executed at the time point when the first image is acquired. That is, the mobile terminal can be configured such that, when a subject previewed through the lens is captured as the first image, the image edit application is executed to display the first image.

In the case of FIG. 2, the image edit process is described with a marquee tool, as an exemplary image edit tool, provided by the image edit application. The mobile terminal activates the marquee tool and selects a specific area of the first image in response to a user command in step 205. The user can select the marquee tool from a tool box provided by the image edit application such that the marquee tool is activated. Once the marquee tool is activated, the mobile terminal defines an area of the first image in accordance with an input event such as a drag event detected on the display screen. The mobile terminal acquires the coordinate values corresponding to the area defined by means of the marquee tool and highlights the selected area. At this time, the marquee-selected area can be provided in the form of a new window on the first image.

Once a specific area has been selected by means of the marquee tool, the mobile terminal activates the camera module to enter the image capture mode in step 207 such that the preview image input through the lens is displayed on the display screen. At this time, the first image is placed in the background so as not to appear explicitly but to be displayed as a background image.

In the image capture mode, the mobile terminal takes a second image by means of the camera module and displays the second image within the marquee selected area of the first image in response to user commands in step 209. At this time, the second image can be resized to fit for the marquee-selected area or cropped to the size of the marquee-selected area. The mobile terminal can display available edit tools with the second image overlapped on the first image as the background.

Next, the mobile terminal monitors to detect an edit command for editing the second image. If an edit command related to the second image is entered by the user, the mobile terminal performs editing of the second image in response to the edit command in step 211. At this time, various visual effects can be applied to the second image. The visual effects include brightness adjustment, color change, contrast adjustment, embossing effect, ghost effect, sepia effect, motion blur effect, etc. Such visual effects can be applied to the first image too, and different effects can be applied to the first and second images. The second image can be resized by adjusting the size of the marquee-selected area.

The mobile terminal synthesizes the second image placed in the marquee-selected area with the first image as the background in response to a user command in step 213. Finally, the mobile terminal saves the new image obtained by synthesizing the first and second image as a third image in response to a user command in step 215.

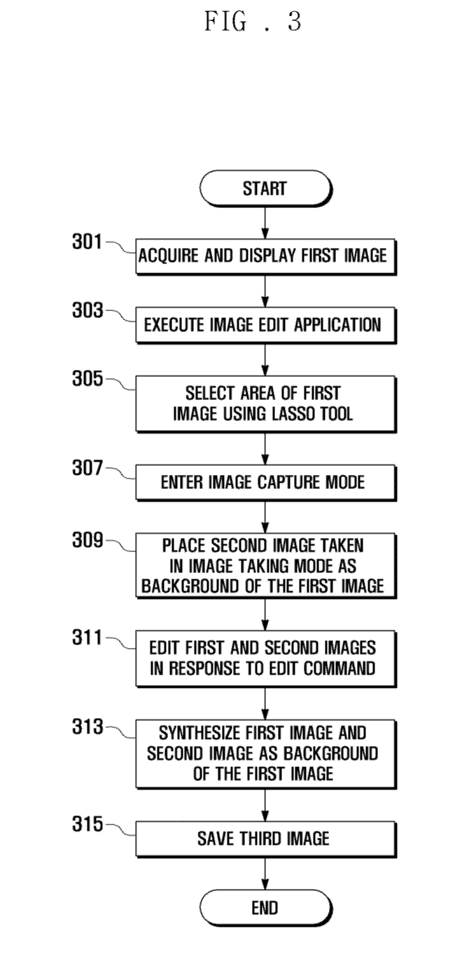

FIG. 3 is a flowchart illustrating an image edit method for a mobile terminal according to an exemplary embodiment of the present invention. More particularly, FIG. 3 illustrates an exemplary image edit procedure in which the first and second images taken by means of a camera module are edited using a lasso tool and the image obtained from the first and second image is saved as a third image.

Referring to FIG. 3, the mobile terminal first acquires and displays a first image on a display screen in step 301. The first image can be a picture taken by means of the camera module of the mobile terminal in response to a user command. In an exemplary embodiment of the present invention, the image can be a still image or a motion image. In FIG. 3, the first image can be a still image or a motion image taken by means of the camera module integrated with the mobile terminal.

While the first image is displayed on the display screen, the mobile terminal executes an image edit application in response to an image edit command entered by the user in step 303. The image edit application can be executed at the time point when the first image is acquired. That is, the mobile terminal can be configured such that, when a subject previewed through a lens is captured as the first image, the image edit application is executed to display the first image. In FIG. 3, the image edit process is described with a lasso tool, as an exemplary image edit tool, provided by the image edit application. The mobile terminal activates the lasso tool and selects a specific area of the first image in response to a user command in step 305. The user can select the lasso tool from a tool box provided by the image edit application such that the lasso tool is activated. Once the lasso tool is activated, the mobile terminal defines an area of the first image in accordance with an input event such as a drag event detected on the touchscreen. Next, the mobile terminal acquires the coordinate values corresponding to the area defined by means of the lasso tool and highlights the selected area. At this time, the lasso-selected area can be cropped such that only the cropped image is displayed.

Once the lasso-selected area has been cropped, the mobile terminal activates the camera module to enter the image capture mode in step 307 such that the preview image input through the lens is displayed on the display screen. At this time, the first image can be placed in the background so as not to appear explicitly on the display screen. Here, the first image is the image obtained by cropping the lasso-selected area.

In the image capture mode, the mobile terminal takes a second image by means of the camera module and displays the second image as a background image of the lasso-cropped first image in step 309. At this time, it is preferred that the lasso-cropped first image is placed at the center of the second image. The position of the lasso-cropped first image can be determined according to a preset configuration of the mobile terminal. For instance, the lasso-cropped first image can be located at one of the center, right upper, right low, left upper, left lower, center upper, and center lower positions.

Next, the mobile terminal monitors to detect an edit command for editing the images. If an edit command is input in association with any or both of the first and second images, the mobile terminal performs editing of the corresponding image in step 311. At this time, various visual effects can be applied to the selected image. The visual effects include brightness adjustment, color change, contrast adjustment, embossing effect, ghost effect, sepia effect, motion blur effect, etc. Such visual effects can be applied to the first and second images selectively, and different effects can be applied to the first and second images respectively. Also, the lasso-cropped first image can be adjusted in size and position freely on the second image. That is, the lasso-cropped first image can be moved and resized according to the user's intention.

Once the first and second images are arranged on the display screen as intended, the mobile terminal synthesizes the lasso-cropped first image with the second image as the background in step 313. Finally, the mobile terminal saves the new image obtained by synthesizing the first and second image as a third image in response to a user command in step 315.

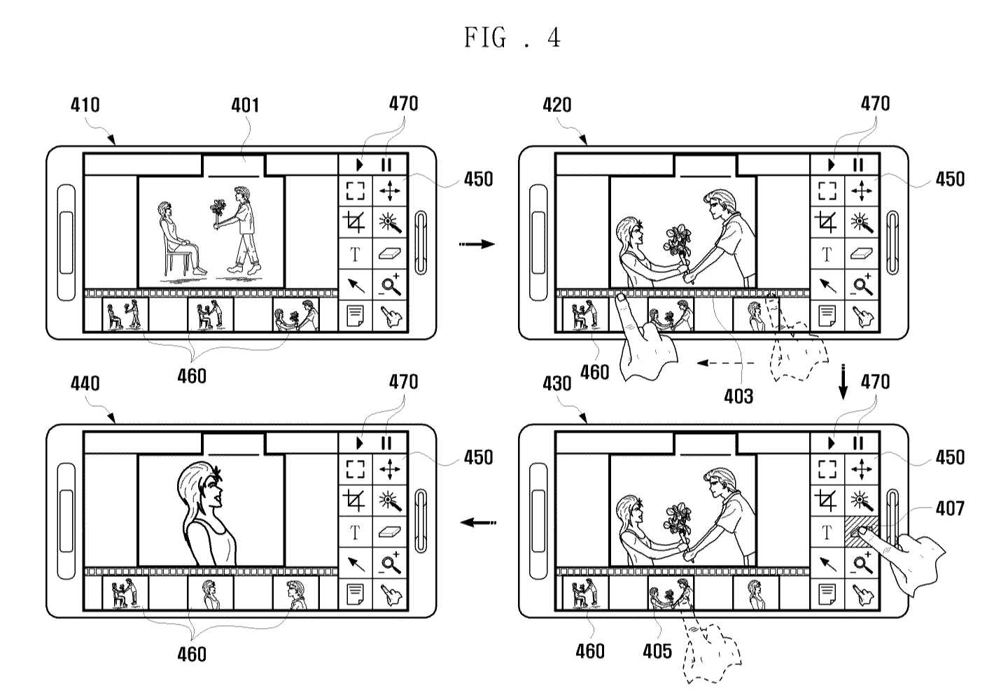

Until now, the image edit procedures using various image edit tools provided by an image edit application have been described. Hereinafter, the steps of the image edit procedures are described in more detail with the exemplary screen images of a mobile terminal. As depicted in FIGS. 4 to 6, the image edit process is performed interactively with the user input by means of the edit tools provided on the touchscreen of the mobile terminal.

FIG. 4 is a diagram illustrating a series of screen images corresponding to steps of a motion image edit method according to an exemplary embodiment of the present invention.

Referring to FIG. 4, a mobile terminal displays a motion image 401 requested by a user within an image edit application window as shown in screen image 410 and discerns the motion image edit mode based on a menu selection of the user. In FIG. 4, an image edit method is described with a process in which the motion image 401 is broken into still image frames 460. The mobile terminal breaks the motion image into image frames 460 and arranges the image frames 460 in the image edit application window together with the motion image 401 in response to an extraction command. The image edit application window is provided with a tool palette 450 including various edit tools. The image edit application window is also provided with control buttons 470 related to playback of the motion image. The control buttons include play, stop, and pause buttons.

The user can search for a target image frame by navigating the series of image frames with a specific touch event 403 on the touchscreen as shown in screen image 420. The touch event can be any of a flick event, a touch & drag event, and a scroll event represented by their corresponding finger gesture.

Once a specific image frame 405 is selected by the user navigating the image frames 460, the mobile terminal displays the selected image frame 405 as an active image frame as shown in screen image 430. Next, the mobile terminal detects an input event 407 for executing a specific function of an edit tool. The input event 407 can be a touch event or a tap event occurring on the touchscreen for selecting a specific tool from the tool palette 450. The edit tool can be any of a delete tool, a move tool, and a copy tool. In addition, the edit tool can be for applying a specific effect such as brightness adjustment, color change, contrast adjustment, embossing effect, ghost effect, sepia effect, and motion blur effect. In FIG. 4, the delete tool is selected for deleting the active image frame.

In response to a user input for selecting the delete tool, the mobile terminal deletes the active image frame as shown in screen image 440 such that the image frames following the deleted image frame is shifted by one frame. If the image edit has completed and an input event for saving the edited image is detected, the mobile terminal saves the motion image obtained by combining the image frames except for the deleted one in response to the save event. At this time, the edited motion image is composed of the image frames of the original motion image except for the deleted image frame. Accordingly, when the edited motion image is played, the motion image is played skipping the deleted image frame.

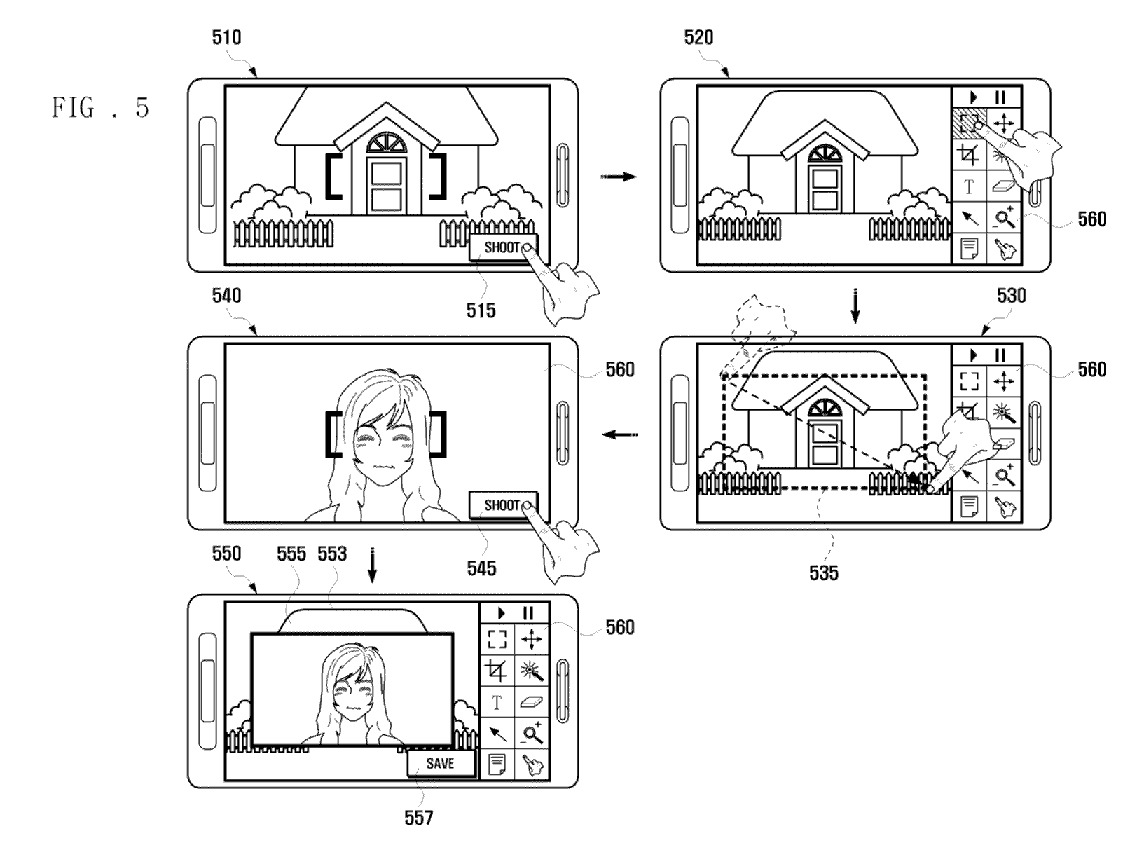

FIG. 5 is a diagram illustrating a series of screen images corresponding to steps of a still image edit procedure using a marquee tool according to an exemplary embodiment of the present invention.

Referring to FIG. 5, a mobile terminal activates a camera module to enter an image capture mode in response to a user command and displays an image input by means of a camera module on its display screen in the form of a preview image as shown in screen image 510. In the image capture mode, the mobile terminal takes a still image by means of the camera module in response to a user command and displays the still image within the image edit application window as shown in screen image 520. Here, the user command for taking the still image can be input by touching or tapping on a shoot button 515 provided at a corner of the display screen.

The image edit application window is provided with a tool palette 560 having diverse edit tools that appears when the still image taken by the camera module is displayed within the image edit application window as shown in screen image 520. While the first image is displayed in the image edit application window, the mobile terminal detects a user command for selecting an edit tool from the tool palette 560 and activates the function corresponding to the selected edit tool. In FIG. 5, the marquee tool is selected from the tool palette 560 (see screen image 520).

Once the marquee tool is selected, the mobile terminal activates the function related to the marquee tool such that the user can select a specific area of the first image by means of the function of the marquee tool as shown in the screen image 530. The area selection can be done in response to a preset event such as a drag event on the touch screen.

After the specific area 535 is selected by means of the marquee tool, the mobile terminal enters the image capture mode again and displays the image input by means of the camera module in the form of a preview image as shown in screen image 540.

Next, the mobile terminal takes a still image by means of the camera module in response to an image capture command and displays the still image within the image edit application window as a second image. Here, the image capture command for taking the still image can be input by touching or tapping on a shoot button 545 provided at a corner of the display screen. At this time, the second image is displayed in the marquee-selected area 555 together with the first image as the background 553 of the second image as shown in screen image 550. The second image can be resized to fit for the marquee-selected area 555 or cropped to the size of the marquee-selected area 555. As described with reference to FIG. 2, at least one of the first and second images can be edited with various edit tools from the tool palette 560.

Once the first and second images are edited and arranged as intended by the user, the mobile terminal saves the image obtained by synthesizing the first and second images in response to a user command. The save command can be input by touch a save button 557 provided at a corner of the display screen.

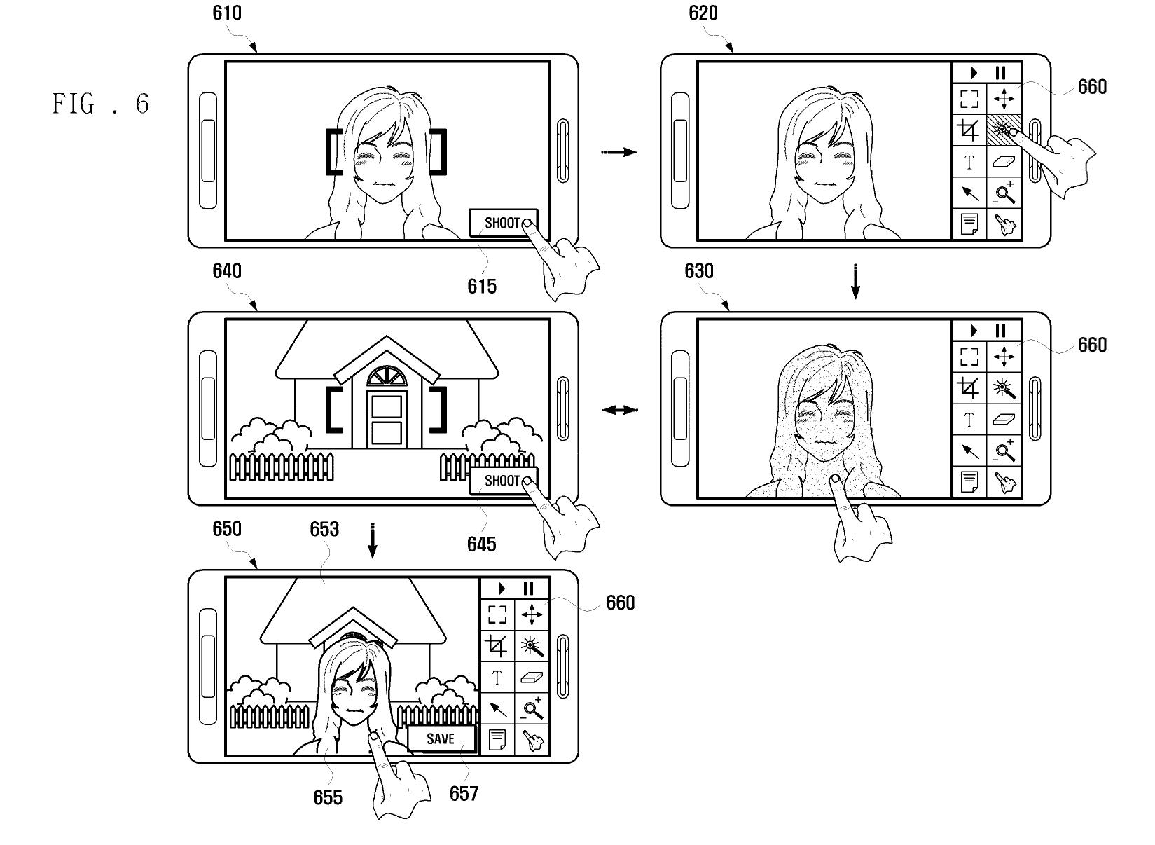

FIG. 6 is a diagram illustrating a series of screen images corresponding to steps of a still image edit procedure using a lasso tool according to an exemplary embodiment of the present invention.

Referring, to FIG. 6, a mobile terminal activates a camera module to enter an image capture mode in response to a user command and displays an image input by means of the camera module on its display screen in the form of a preview image as shown in screen image 610. In the image capture mode, the mobile terminal takes a still image by means of the camera module in response to a user command and displays the image on the display unit as shown in the screen image 620. Here, the user command for taking the still image can be input by the user touching or tapping on a shoot button 615 provided at a corner of the display screen.

The image edit application window is provided with a tool palette 660 having diverse edit tools that appears when the still image taken by the camera module is displayed within the image edit application window as shown in screen image 620. While the first image is displayed in the image edit application window, the mobile terminal detects a command input by the user for selecting an edit tool from the tool palette 660 and activates the function related to the selected edit tool. In FIG. 6, the lasso tool is selected from the tool palette 660 (see screen image 620).

Once the lasso tool is selected, the mobile terminal activates the function related to the lasso tool such that the user can select a specific area of the first image by means of the lasso tool and crops the selected area as shown in screen image 630. The application of the lasso tool can be done by a preset touch event such as a touch & drag event on the touchscreen.

Once an area of the first image has been selected and cropped with the lasso tool, the mobile terminal enters the image capture mode again and displays the image input by means of the camera module on its display screen in the form of a preview image as shown in screen image 640.

Next, the mobile terminal takes a still image by means of the camera module in response to a user command and saves the still image as a second image 653. Here, the user command for taking the still image can be input by touching or tapping on a shoot button 645 provided at a corner of the display screen. The second image 653 is displayed as the background of the cropped first image 655 within the image edit application window as shown in screen image 650. The cropped first image 655 can be moved over the second image 653 in response to a user command. While moving the cropped first image 655, the second image is fixed as the background. As described with reference to FIG. 3, at least one of the first and second images can be edited with various edit tools.

Once the first and second images are edited and arranged as intended by the user, the mobile terminal saves the image obtained by synthesizing the first and second image in response to a user command. The save command can be input by touching a save button 657 provided at a corner of the display screen.

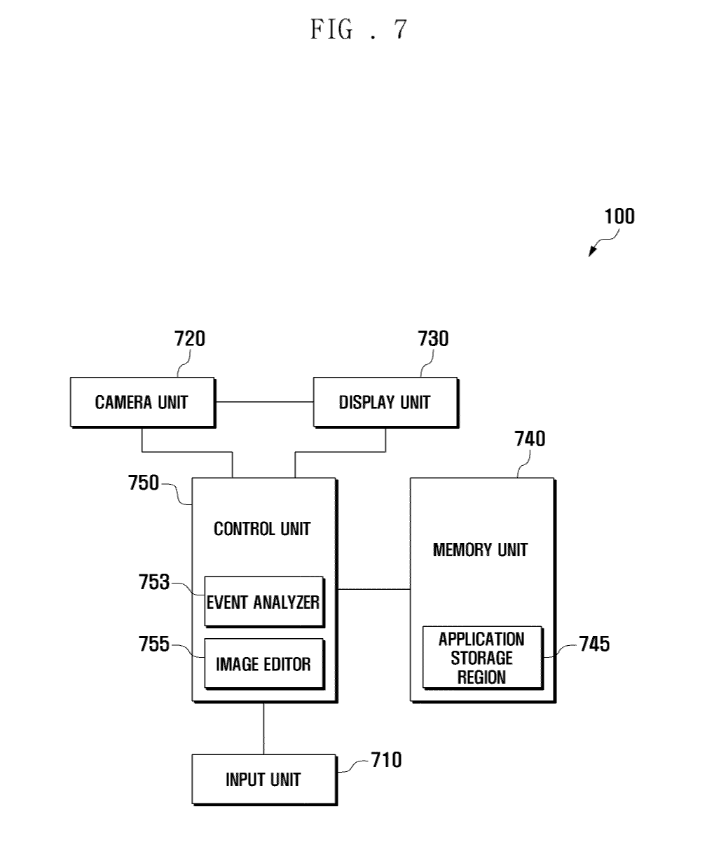

The mobile terminal can be any of a Personal Digital Assistant (PDA), a Portable Multimedia Player (PMP), an MP3 player, a digital broadcast player, a cellular phone, and their equivalent devices equipped with a camera module and a touchscreen. Structures and functions of the mobile terminal according to an exemplary embodiment are described hereinafter with reference to FIG. 7.

FIG. 7 is a block diagram illustrating a configuration of a mobile terminal according to an exemplary embodiment of the present invention.

As illustrated in FIG. 7, the mobile terminal 100 according to an exemplary embodiment of the present invention includes an input unit 710, a camera unit 720, a display unit 730, a storage unit 740, and a control unit 750.

The input unit 710 is provided with a plurality of alphanumeric keys for entering alphabetic and numeric data and a plurality of functions keys for entering control and configuration information for the mobile terminal. More particularly in an exemplary embodiment of the present invention, the input unit 710 includes a touchpad as an auxiliary input means or is implemented with a touchpad. The input unit 710 can be implemented with at least one of a touchpad, a touchscreen, a normal keypad, a QWERTY keypad, and special function key module according to the design of the mobile terminal.

The camera unit 720 captures an image of an object and outputs image data indicative of the image to the display unit 730 and the control unit 750. The camera unit 720 includes an image sensor (not shown) such as a Charge Coupled Device (CCD) or a Complementary Metal Oxide Semiconductor (CMOS) for converting optical signals into an electric signal and an image processor (not shown) for converting the electric signal into video data and processing the video data.

The display unit 730 displays operation status of applications running in the mobile terminal 100, data input through the input unit 710, and setting information of the mobile terminal 100. The display unit 730 is configured to display the image taken by the camera unit 720 under the control of the control unit 750 and color and informative data output by the control unit 750. The display unit 730 can be implemented with a Liquid Crystal Display (LCD) panel, an Organic Light Emitting Diode (OLED) panel, and the like. If the display unit 730 is implemented with a LCD panel, the display unit 730 is provided with an LCD controller, a video memory for buffering the video data, and LCD devices. Similarly, if the display unit 730 is implemented with an OLED panel, the display unit 730 is provided with an OLED controller, a video memory for buffering the video data, and OLED devices.

The display unit 730 can be implemented with touchscreen functionality such that a user can input data by touching the screen with a finger or a stylus pen. The touchscreen senses the discernable touch events (touch, touch & drag, tap, etc.) that occurred thereon and outputs the signal indicative of the touch event to the control unit 750. That is, the touchscreen-enabled display unit provides an interactive user interface to detect the type and position of a touch event such that the mobile terminal executes a function corresponding to the touch event. In short, the touchscreen is a display device that can detect the presence and location of a touch within the display screen.

The touchscreen functionality is implemented by laminating a touch panel on the surface of the display unit 730. The touch panel operates with a grid of infrared rays crossing over its surface so as to identify an input event based on the touch location and movement. If an input event is detected at a position on the touchscreen, the control unit 750 determines the user instruction based on the touch location and movement and outputs a control command. Accordingly, the user can control the operation of the mobile terminal intuitively.

For instance, when the user places a finger or a stylus at a position in touch with the touchscreen, the touch screen sends the coordinate of the contact position to the control unit 750 such that the control unit 750 executes a function linked to the coordinate in consideration of the screen image. The control unit 750 also can control such that the currently displayed image is set as the background of a new image taken by the camera unit 720 in response to the input event.

That is, the display unit 730 detects a user command input by means of a touch event on the touchscreen and sends a signal indicative of the user command to the control unit 750. The display unit 730 equipped with a touchscreen operates as shown in FIGS. 1 to 6.

The storage unit 730 stores various data created and used in association with the operation of the mobile terminal 100. In more detail, the data can include the application data required for running the applications installed in the mobile terminal and user data created in the mobile terminal or downloaded from outside. The application and user data include the images defined in the exemplary embodiments of the present invention. The data can include the user interface provided by the mobile terminal 100 and settings configured by the user.

The storage unit 740 can be implemented with at least one of a Read Only Memory (ROM) and a Random Access Memory (RAM). More particularly, in an exemplary embodiment of the present invention, the storage unit 740 stores the still and motion images taken by means of the camera unit 720 and the images obtained by editing and/or synthesized using an image edit application. The storage unit 740 also can store metadata (such as a file name assigned by the user) of the image data. The storage unit 740 stores a plurality of application programs including the image edit application programs for editing the images taken by the camera unit 720 according to an exemplary embodiment of the present invention and an Operating System (OS) for running application programs. The image edit application programs run so as to accomplish the image edit method as shown in FIGS. 1 to 6. The application programs can be stored within an application storage region 745 of the storage unit 740.

The storage unit 740 can provide at least one buffer for buffering the data generated while the application programs are running. The storage unit 740 can be implemented as an internal part of the mobile terminal 100 or as external storage media such as a smart card. The storage unit 740 also can be implemented with both internal and external storage media.

The control unit 750 controls general operations of the mobile terminal 100 and signaling among the internal function blocks of the mobile terminal 100. That is, the control unit 750 controls signaling among the input unit 710, the camera unit 720, the display unit 730, and the memory unit 740. The control unit 750 may be integrated with a data processing unit having at least one codec and at least one modem for processing communication data. In a case where the mobile terminal 100 supports a cellular communication service, the mobile terminal 100 further includes a Radio Frequency (RF) unit for processing the cellular radio signals.

More particularly, in an exemplary embodiment of the present invention, the control unit 750 activates and controls the camera unit 720 to take an image in response to a user command input through the input unit 710 or the display unit 730. The control unit 750 executes an image edit application in response to a user command and controls the display unit 730 to display an image edit application window with an image (first image) taken by the camera unit 720 together with a tool palette having diverse edit tools. The control unit 750 edits the first image displayed in the image edit application window by means of an edit tool selected from the tool palette in response to a user command.

In an exemplary embodiment of the present invention, the tool palette includes a marquee tool and a lasso tool. The user can select a specific area of the first image using the marquee tool or the lasso tool under the control of the control unit 750. When the target area is selected by means of the marquee or lasso tool as intended by the user, the control unit 750 controls the camera unit 720 to take another picture (second picture) and displays the second picture with the first image on the display unit 750.

In a case where the target area is selected by means of the marquee tool, the control unit 750 sets the first image as the background of the second image such that the second image is placed within the marquee-selected area of the first image. In a case where the target area is selected by means of the lasso tool, the control unit 750 sets the second image as the background of the first image such that the lasso-selected area of the first image is overlapped on the second image.

The control unit 750 also can apply various visual effects to the first and second images using edit tools selected by the user. The visual effects may include brightness adjustment, color change, contrast adjustment, embossing effect, ghost effect, sepia effect, motion blur effect, etc.

The control unit 750 also can edit a motion image. In this case, the control unit 750 can break a motion image into a plurality of still image frames and edit at least one still image frame in accordance with the user manipulation.

The operations of the control unit 750 correspond to the processes depicted in FIGS. 1 to 6, and function control operation can be implemented as software.

The control unit 750 includes an event analyzer 753 and an imaged editor 755. The event analyzer 753 can analyze the input event detected on the touchscreen. The event analyzer 753 also analyzes the requests for editing the image. The event analyzer 753 activates the function of the edit tool selected by the user and determines a command corresponding to an input event in association with the function.

The image editor 755 executes the edit command output by the event analyzer 753. The image editor 755 can execute the commands corresponding to the various edit-tool related input events.

The operations of the event analyzer 753 and the image editor 755 correspond to the processes depicted in FIGS. 1 to 6.

Although the mobile terminal 100 is depicted schematically in FIG. 7 for the simplicity's sake, the present invention is not limited to thereto. For instance, the mobile terminal 100 may further include at least one of a digital broadcast reception unit, a short range communication unit, an Internet access unit, a music player unit, and their equivalent devices, depending on the design of the mobile terminal. In a case where the mobile terminal 100 is a cellular phone, the mobile terminal may include a communication module for supporting communication service provided by a cellular network. The communication module may include a codec and a modem dedicated to the cellular communication network. Accordingly, it is obvious to those of skill in the art that each of the internal function blocks constituting the mobile terminal can be omitted or replaced with an equivalent device according to the design and purpose of the mobile terminal.

For instance, the mobile terminal may include a short range communication module such as a Bluetooth module or a Zigbee module such that the mobile terminal communicates with another device by means of the short range communication module. In a case where the mobile terminal 100 is designed for supporting Internet access, it may include an Internet Protocol (IP) communication module for communicating with another terminal via the IP network. The mobile terminal 100 also can include a digital broadcast reception module for receiving and playing digital broadcast data.

As described above, the image edit method and apparatus for a mobile terminal according to exemplary embodiments of the present invention allow the user to edit images intuitively using the touchscreen of the mobile terminal.

In addition, the image edit method and apparatus for a mobile terminal according to exemplary embodiments of the present invention allow the user to acquire images from various sources and produce a new image by synthesizing the images.

Also, the image edit method and apparatus for a mobile terminal according to exemplary embodiments of the present invention allow editing of images intuitively with various edit tools displayed on the touchscreen of the mobile terminal without need to remember the edit history, thereby resulting in a reduction of manipulation complexity and an increase in user's convenience.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims and their equivalents.

What is claimed is:

1. An image edit method for a mobile terminal, the method comprising:
displaying a first image with an edit tool;
breaking, when the first image is a motion picture, the first image into a plurality of frames and
editing at least one of the frames using the edit tool in accordance with user manipulation; and
acquiring, when the first image is a still image, a second image from an image source; and
generating a third image by synthesizing the first and second images.

2. The method of claim 1, wherein the editing of the at least one of the frames comprises generating a new motion picture by combining the frames after the at least one frame is edited.

3. The method of claim 1, wherein the generating of the third image comprises:
selecting an area of the first image using the edit tool;
displaying the second image within the selected area with the first image as a background of the second image; and
merging the first and second images.

4. The method of claim 3, wherein the selecting of the area of the first image comprises entering an image capturing mode, capturing a new image, and processing the new image to generate the second image.

5. The method of claim 1, wherein the generating of the third image comprises:
selecting an area of the first image using the edit tool;
cropping the selected area as a cropped first image;
displaying the cropped first image with the second image as a background of the cropped first image; and
merging the cropped first image and the second image.

6. The method of claim 5, wherein the selecting of the area of the first image comprises entering an image capturing mode and capturing the second image.

7. An image edit method for a mobile terminal having a touchscreen, the method comprising:
displaying a first image with an edit tool in the touchscreen;
selecting an area of the first image using a marquee function of the edit tool;
capturing a second image after selecting the area of the first image;
placing the second image within the selected area of the first image; and
generating a third image by synthesizing the second image and first image as a background of the second image.

8. The method of claim 7, further comprising editing at least one of the first and second images using at least one function of the edit tool.

9. The method of claim 7, wherein the selecting of the area of the first image comprises defining the area by means of the marquee function in response to an input event detected on the touchscreen.

10. The method of claim 7, further comprising adjusting a size of the second image to fit for the selected area of the first image.

11. The method of claim 7, wherein the generating of the third image comprises:
selecting an area of the first image using a lasso function of the edit tool;
capturing a second image after selecting the area of the first image;
overlaying the selected area of the first image on the second image; and
generating a third image by synthesizing the selected area of the first image and the second image as a background of the selected area.

12. The method of claim 11, further comprising editing at least one of the first and second images using at least one function of the edit tool.

13. The method of claim 12, wherein the editing of the at least one of the first and second images comprises resizing the selected area of the first image and changing a position of the selected area on the second image.

14. The method of claim 11, wherein the selecting of the area of the first image comprises defining the area by means of the lasso function in response to an input event detected on the touchscreen.

15. A mobile terminal having a camera unit, the terminal comprising:
a display unit for displaying at least one image taken by means of the camera unit together with an edit tool and for detecting an input event by means of a touchscreen; and
a control unit for controlling the display unit to display a first image taken by the camera unit together with the edit tool, for controlling the camera unit to capture a second image when the first image is edited, and for generating a third image by synthesizing the first and second images.

16. The terminal of claim 15, wherein the control unit breaks, when the first image is a motion picture, the first image into a plurality of frames and edits at least one of the frames using at least one function of the edit tool; and
the control unit produces a new motion picture by combining the frames after the at least one frame is edited.

17. The terminal of claim 15, wherein the control unit selects an area of the first image using the edit tool, displays the second image within the selected area, and merges the first and second images.

18. The terminal of claim 17, wherein the control unit adjusts a size of the second image to fit for the selected area of the first image.

19. The terminal of claim 15, wherein the control unit selects an area of the first image and produces a new image by merging the selected area of the first image with the second image as the background of the selected area of the first image.

20. The terminal of claim 19, wherein the control unit adjusts a size and position of the selected area of the first image on the second image.
